(19) United States
(12) Patent Application Publication
(10) Pub. No.: US 2014/0297539 A1
(43) Pub. Date: Oct. 2, 2014

(54) DONGLE DEVICE WITH RECHARGEABLE POWER SUPPLY FOR A SECURE ELECTRONIC TRANSACTION

(71) Applicant: EZETAP MOBILE SOLUTIONS PRIVATE LIMITED, BANGALORE (IN)

(72) Inventors: Sanjay Swamy, Bangalore (IN); Bhaktha Ram Keshavachar, Bangalore (IN)

(73) Assignee: EZETAP MOBILE SOLUTIONS PROVATE LIMITED, BANGALORE (IN)

(21) Appl. No.: 14/349,149

(22) PCT Filed: Sep. 28, 2012
(86) PCT No.: PCT/IN2012/000650

§ 371 Date: Apr. 21, 2014

(30) Foreign Application Priority Data
Oct. 3, 2011 (IN) 3415/CHE/2011

(51) Int. Cl. G06Q 20/40; G06K 7/00

(52) U.S. Cl. CPC G06Q 20/4012; G06K 7/0004
USPC 705/71; 235/440

(57) ABSTRACT

The various embodiments herein provide a dongle device with rechargeable power supply for a secure electronic transaction. The dongle device comprises a slot for swiping a magnetic stripe card, a slot for inserting a contact type card, a rechargeable battery, a recharging circuit, a key pad, a key pad cover, a connector, wherein the connector is an audio jack, a cover for safeguarding the connector, a stylus, a universal serial bus (USB) port, a processor and a display. The rechargeable battery is powered by the recharging circuit when a residual battery level of the rechargeable battery falls below a preset value. The key pad is used to enter PIN and the key pad cover prevents an onlooker from viewing and learning the PIN entered by a user.

### CROSS REFERENCE TO RELATED APPLICATION

The present application is a national phase application to the PCT Application entitled, “A DONGLE DEVICE WITH RECHARGEABLE POWER SUPPLY FOR A SECURE ELECTRONIC TRANSACTION” with serial number PCT/IN 2012/000650, filed at Government of India Patent Office on Sep. 28, 2012, the content of which is incorporated by reference herein.

The present application claims the benefit of an Indian Provisional Patent Application entitled, “SYSTEM AND METHOD FOR SECURE ELECTRONIC TRANSACTION” with serial number 3415/CHE/2011, filed at Government of India Patent Office on Oct. 3, 2011, the content of which is incorporated by reference herein.

### BACKGROUND

1. Technical Field

The embodiments herein generally relate to a field of electronic transaction. The embodiments herein particularly relate to a dongle device for an electronic transaction and more particularly relates to a dongle device with a rechargeable power supply for a secure electronic transaction.

2. Description of the Related Art

Currently, there are hundreds of magnetic stripe readers/swipers on the market. All of them are at least as long as the credit card itself. There are different types of card readers/swipers exist in the market. One of the types is a traditional card swiper with a single rail, which allows a card to be held against a base of the reader by a user and moved across a read head of the reader. Another type of a card reader guides a card by a two sets of rails and a backstop. When the user has inserted the card against the backstop, the card is read as it is removed from the swiper. The magnetic stripe cards having the standard specifications can typically be read by the point-of-sale devices at a merchant location. When the card is swiped through an electronic card reader at a checkout counter in a merchant store, the reader usually uses a built-in modem to dial a number of a company that handles the credit authentication requests. After an account is verified, an approval signal is sent back to the merchant to complete a transaction.

The conventional swipe device using the magnetic card readers for an electronic payment is bulky. Further the merchant has to produce the printed receipts for the customer, which is very cumbersome for the merchant handling the multiple customers. Also the merchant has to keep a record of all the printed receipts, to avoid a dispute about the transactions. It is advantageous for an individual to make a payment to another individual or merchant by swiping his magnetic stripe card through a reader connected to a mobile device. The mobile device should include a communication medium such as GPRS, WiFi, Bluetooth, etc., to transmit the card data to the server. Further the mobile device should be carried everywhere.

At present, there were huge developments in providing the card reader for a mobile device. In the currently available systems, a portable swipe machine is provided for the mobile devices and the card data is encrypted on the mobile device. Hence there is a chance of an insecure transaction over the mobile device. Further the existing systems communicate the relevant data through the electrical signals, which are extremely slow compared to the electromagnetic signals. In the current scenario, the communication is always performed on an IP network, since the IP networks are wide spread. Further the existing devices work only with the high end devices such as iPhone, iPad or any other smart phone, thereby making the system very costly for the prospective users. Further the swipe machines used presently are active devices, where the machines need to be charged with an external power supply or through a connected device.

In view of the above facts, there is a need for a secure electronic transaction. There is also a need for a system and a method for providing a secure electronic transaction in a cost effective manner. Further there is a need for a system and a method to enable a fast, efficient and secure electronic transaction by using a dongle device. Yet there is a need for a dongle device with a rechargeable power supply for a secure electronic transaction. Yet there is also a need for a system and method to utilize the fast and efficient IP communication, thereby reducing the need for the use of electrical signal.

The above mentioned shortcomings, disadvantages and problems are addressed herein and which will be understood by reading and studying the following specification.

### Objects of the Embodiments

The primary object of the embodiments herein is to provide a dongle device for a secure electronic transaction.

Another object of the embodiments herein is to provide a dongle device with tamper proof characteristics for a secure electronic transaction.

Yet another object of the embodiments herein is to provide a dongle device with a rechargeable power supply for a secure electronic transaction.

Yet another object of the embodiments herein is to provide a dongle device with a security mesh to prevent a drilling to avoid a tampering of key board.

Yet another object of the embodiments herein is to provide a method to transform a card data into a token data and to transmit the token data without sending the card data from a computing device to a server.

Yet another object of the embodiments herein is to provide a method for converting the card data into audio data at supersonic frequencies.

Yet another object of the embodiments herein is to provide a method for converting the card data into noise like signals i.e. spread spectrum signals.

Yet another object of the embodiments herein is to provide a method and system for mutually authenticating the dongle device and the payment server.

These and other objects and advantages of the embodiments herein will become readily apparent from the following detailed description taken in conjunction with the accompanying drawings.

### SUMMARY

The various embodiments of the embodiments herein provide a dongle device with a rechargeable power supply for a secure electronic transaction. The dongle device comprises a slot for swiping a magnetic stripe card, a slot for inserting a contact type card, a rechargeable battery, a recharging circuit, a key pad, a key pad cover, a connector, a cover for safeguarding the connector, a stylus, a universal serial bus (USB) port, a processor and a display. The connector is an audio jack. The rechargeable battery is powered by the recharging circuit when a residual battery level of the rechargeable battery falls below a preset value. The key pad is used to enter PIN and the key pad cover prevents an onlooker from viewing and learning the PIN entered by a user.

According to an embodiment herein, the PIN data is any one of a scrambled PIN data or a PIN block or a onetime password.

According to an embodiment herein, the pre-set value is set by a user.

According to an embodiment herein, the dongle device further comprises a public key burned at a time of manufacture the dongle.

According to an embodiment herein, the processor generates a session key and a secret key at a beginning of the transaction. The secret key is used for authenticating the payment server. The session key and secret key are encrypted by the public key before sending to the payment server.

According to an embodiment herein, the payment server of the embodiments herein further comprises a private key. The private key decrypts the secret key sent by the dongle and sends back the decrypted secret key to the dongle for mutually authenticating the dongle and the payment server.

According to an embodiment herein, the dongle device further comprises a magnetic card reader, a contact type card reader and a NFC reader.

According to an embodiment herein, the magnetic card reader or a contact type card reader or the NFC reader is activated accordingly when a magnetic card is swiped through the slot for swiping a magnetic stripe card or when a contact type card is inserted through the slot for inserting a contact type card or when a NFC card is tapped.

According to an embodiment herein, the connector comprises a power module, line detector module and a line for establishing a bi-directional data communication.

According to an embodiment herein, the connector provides a mechanical support.

According to an embodiment herein, the processor is provided with software to convert the card data into audio data at supersonic frequencies.

According to an embodiment herein, the communication module interacts with a payment gateway server for completing a transaction.

According to an embodiment herein, the payment transaction is made through a mobile phone connected to the audio jack of the dongle device.

According to an embodiment herein, the audio jack supports a payment transaction during a listening of music by enabling transmission at audible and supersonic frequencies simultaneously.

According to an embodiment herein, the communication module links a transaction originated in a cloud computing server with a payment gateway server through a mobile phone to complete a financial transaction.

According to an embodiment herein, the processor interacts with a central server through a mobile phone or with the central server directly. The central server is the server of a dongle manufacturer

According to an embodiment herein, the processor interacts not only with the central server through a mobile phone but also with the payment gate way server.

According to an embodiment herein, the audio jack supports both a data transmission and an audio transmission with the mobile phone.

According to an embodiment herein, the audio jack supports a two way communication between a mobile phone and the dongle.

According to an embodiment herein, the audio jack supports a two way encrypted link.

According to an embodiment herein, the communication over the audio jack is done through a noise like signals and wherein the noise like signals is spread spectrum signals and wherein the spread spectrum signals are generated using hardware and software.

The various embodiments herein provide a method for a secure electronic transaction using a dongle device. The method for a secure electronic transaction using a dongle device comprises the steps of logging in by a merchant into a client application installed on a computing device, swiping a card onto a dongle device, tracking a status of a swipe, reading a swipe data by a magnetic card reader of the dongle device, extracting a public key burnt on a flash of the dongle device, processing the swipe data by a microchip for producing a cipher data, representing the cipher data and a PIN data as an audio signal, transmitting the cipher data and the PIN data to a mobile device through an audio jack of the mobile device, and wherein the data communicated between the mobile phone and the dongle device is in a form of acoustic signals or audio tones, collecting a transaction information through a graphical user interface (GUI) and wherein the GUI is provided by the client application, collecting a part of a card number from the merchant, constructing a hash value out of the cipher data by using a hash algorithm of a client application running on a computing device and wherein the hash algorithm is exchanged and stored between the mobile device and the payment server for a first time, transmitting the hash value along with the transaction information to a production server through a first communication network, processing the cipher data and the PIN data in a payment server of the production server, sending a transaction request to a third party system to perform an electronic transaction, transmitting a transaction information to the third party system through a second communication network, performing the electronic transaction by the third party system and indicating a transaction status and wherein the transaction status is indicated by an audio tone or a colored light, and wherein the transaction status is one of a bad transaction and a good transaction.

According to an embodiment herein, the step for processing the swipe data by a microchip for producing a cipher data comprises the step for generating a random number for avoiding a replay attack, decoding the swipe data by a comparator, converting the swipe data into a card data by a converter, tokenization of the card data by a tokenizer by Xoring the card data with a dongle ID, encrypting the card data into a cipher data by an encryption engine using a RSA algorithm, and wherein a public key is used in RSA algorithm for encrypting the card data and modulating the cipher data by a modulation engine using Frequency Shift Keying (FSK). The dongle ID is a unique and secret ID related to the dongle device.

According to an embodiment herein, the step for processing the cipher data in a payment server of the production server comprises decoding the hash value by a decoder of the payment server for producing the cipher data, decrypting the cipher data by a decryption engine of the payment server using a private key, retrieving a merchant information stored in a payment database of the production server, reproducing a complete card number by stitching a part of the card number entered by the merchant with a card data received from the dongle device and authenticating the merchant.

According to an embodiment herein, the step of representing the cipher data as an audio signal comprises filtering the cipher data by a low pass filter and dividing a voltage of cipher data for producing amplitude for the audio signal.

According to an embodiment herein, the step of constructing the hash value out of the encrypted data by the hash function of the client application running on the mobile phone is done by creating a date/time stamp.

According to an embodiment herein, the method for a secure electronic transaction using a dongle device further comprises sending an electronic receipt to the customer through a short message service (SMS) or an e-mail.

According to an embodiment herein, the method for a secure electronic transaction using a dongle device further comprises recording a transaction status by a counter of the microchip.

According to an embodiment herein, the method for a secure electronic transaction using a dongle device further comprises measuring a voltage level of a battery of the dongle by an analog-to-digital convertor (ADC) of the microprocessor, sending a measured voltage level along with the transaction data to the production server, collating a reading of the battery by the payment server, computing a remaining voltage level in the battery by the payment server and sending an information corresponding to the remaining voltage level in the battery to a user.

According to an embodiment herein, the transaction information includes an amount of the transaction, a unique PIN data of the card entered by the card holder, an additional data related to the transaction and a signature of a card holder.

According to an embodiment herein, the unique PIN is data is any one of a scrambled PIN data or a PIN block or a onetime password (OTP).

According to an embodiment herein, the method further comprises an updating of the public key. The updating of the public key comprises swiping a non financial card on a swipe machine, reading a swipe data by a reader head of the dongle device, extracting a public key from the swipe data and updating the public key associated with the dongle device.

According to an embodiment herein, the method further comprises mapping a merchant ID, a terminal ID, a user ID, an IMEI number of computing device, a serial number of the dongle with a dongle ID for executing a secure electronic transaction.

According to an embodiment herein, the method further comprises mapping a dongle ID, a serial number of dongle with the IMEI number of a mobile phone for executing a secure electronic transaction.

According to an embodiment herein, the public key is burned to the dongle device at a manufacture time.

According to an embodiment herein, the dongle generates a session key and a secret key at the beginning of the transaction. The secret key is used for authenticating the payment server. The session key and secret key are encrypted by the public key and sent to the payment server.

According to an embodiment herein, the payment server further comprises a private key and the private key decrypts the secret key sent by the dongle and sends back the decrypted secret key to the dongle for mutually authenticating the dongle device and the payment server.

According to an embodiment herein, the dongle device further comprises a NFC tag and the NFC tag of the dongle device includes a unique ID and a physical unclonable function (PUF).

According to an embodiment herein, the merchant device comprises a NFC tag and the NFC tag of the merchant device authenticates the dongle device by verifying the unique ID of the dongle NFC tag.

According to an embodiment herein, the card data alone is sent as an audio signal after tokenization and encryption.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a top perspective view of a dongle device with a cover, according to an embodiment herein.

FIG. 2 illustrates a front view of a dongle device with a cover, according to an embodiment herein.

FIG. 3 illustrates a back view of a dongle device, according to an embodiment herein.

FIG. 4 illustrates a left side view of a dongle device without a cover, according to an embodiment herein.

FIG. 5 illustrates a right side view of a dongle device without a cover, according to an embodiment herein.

FIG. 6 illustrates a functional block diagram of a dongle device with a rechargeable power supply for a secure electronic transaction, according to an embodiment herein.

FIG. 7A and FIG. 7B jointly illustrates a flowchart indicating a method for a secure electronic transaction, according to an embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS HEREIN

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments of the embodiments herein provide a dongle device with rechargeable power supply for a secure electronic transaction. The dongle device comprises a slot fir swiping a magnetic stripe card, a slot for inserting a contact type card, a rechargeable battery, a recharging circuit, a key pad, a key pad cover, a connector, wherein the connector is an audio jack, a cover for safeguarding the connector, a stylus, a universal serial bus (USB) port, a processor and a display. The rechargeable battery is powered by the recharging circuit when a residual battery level of the rechargeable battery falls below a preset value. The key pad is used to enter PIN and the key pad cover prevents an onlooker from viewing and learning the PIN entered by a user.

According to an embodiment herein, the PIN data is any one of a scrambled PIN data or a PIN block or a onetime password.

According to an embodiment herein, the preset value is set by a user.

According to an embodiment herein, the dongle device further comprises a public key burned at a time of manufacture the dongle.

According to an embodiment herein, the processor generates a session key and a secret key at a beginning of the transaction. The secret key is used for authenticating the payment server. The session key and secret key are encrypted by the public key before sending to the payment server.

According to an embodiment herein, the payment server of the embodiments herein further comprises a private key. The private key decrypts the secret key sent by the dongle and sends back the decrypted secret key to the dongle for mutually authenticating the dongle and the payment server.

According to an embodiment herein, the dongle device further comprises a magnetic card reader, a contact type card reader and a NFC reader.

According to an embodiment herein, the magnetic card reader or a contact type card reader or the NFC reader is activated accordingly when a magnetic card is swiped through the slot for swiping a magnetic stripe card or when a contact type card is inserted through the slot for inserting a contact type card or when a NFC card is tapped.

According to an embodiment herein, the connector comprises a power module, line detector module and a line for establishing a bi-directional data communication.

According to an embodiment herein, the connector provides a mechanical support.

According to an embodiment herein, the processor is provided with software to convert the card data into audio data at supersonic frequencies.

According to an embodiment herein, the communication module interacts with a payment gateway server for completing a transaction.

According to an embodiment herein, the payment transaction is made through a mobile phone connected to the audio jack of the dongle device.

According to an embodiment herein, the audio jack supports a payment transaction during a listening of music by enabling transmission at audible and supersonic frequencies simultaneously.

According to an embodiment herein, the communication module links a transaction originated in a cloud computing server with a payment gateway server through a mobile phone to complete a financial transaction.

According to an embodiment herein, the processor interacts with a central server through a mobile phone or with the central server directly. The central server is the server of a dongle manufacturer.

According to an embodiment herein, the processor interacts not only with the central server through a mobile phone but also with the payment gate way server.

According to an embodiment herein, the audio jack supports both a data transmission and an audio transmission with the mobile phone.

According to an embodiment herein, the audio jack supports a two way communication between a mobile phone and the dongle.

According to an embodiment herein, the audio jack supports a two way encrypted link.

According to an embodiment herein, the communication over the audio jack is done through a noise like signals and wherein the noise like signals is spread spectrum signals and wherein the spread spectrum signals are generated using hardware and software.

The various embodiments herein provide a method for a secure electronic transaction using a dongle device. The method for a secure electronic transaction using a dongle device comprises the steps of logging in by a merchant into a client application installed on a computing device, swiping a card onto a dongle device, tracking a status of a swipe, reading a swipe data by a magnetic card reader of the dongle device, extracting a public key burnt on a flash of the dongle device, processing the swipe data by a microchip for producing a cipher data, representing the cipher data and a PIN data as an audio signal, transmitting the cipher data and the PIN data to a mobile device through an audio jack of the mobile device, and wherein the data communicated between the mobile phone and the dongle device is in a form of acoustic signals or audio tones, collecting a transaction information through a graphical user interface (GUI) and wherein the GUI is provided by the client application, collecting a part of a card number from the merchant, constructing a hash value out of the cipher data by using a hash algorithm of a client application running on a computing device and wherein the hash algorithm is exchanged and stored between the mobile device and the payment server for a first time, transmitting the hash value along with the transaction information to a production server through a first communication network, processing the cipher data and the PIN data in a payment server of the production server, sending a transaction request to a third party system to perform an electronic transaction, transmitting a transaction information to the third party system through a second communication network, performing the electronic transaction by the third party system and indicating a transaction status and wherein the transaction status is indicated by an audio tone or a colored light, and wherein the transaction status is one of a bad transaction and a good transaction.

According to an embodiment herein, the step for processing the swipe data by a microchip for producing a cipher data comprises the step for generating a random number for avoiding a replay attack, decoding the swipe data by a comparator, converting the swipe data into a card data by a converter, tokenization of the card data by a tokenizer by Xoring the card data with a dongle ID, encrypting the card data into a cipher data by an encryption engine using a RSA algorithm, and wherein a public key is used in RSA algorithm for encrypting the card data and modulating the cipher data by a modulation engine using Frequency Shift Keying (FSK). The dongle ID is a unique and secret ID related to the dongle device.

According to an embodiment herein, the step for processing the cipher data in a payment server of the production server comprises decoding the hash value by a decoder of the payment server for producing the cipher data, decrypting the cipher data by a decryption engine of the payment server using a private key, retrieving a merchant information stored in a payment database of the production server, reproducing a complete card number by stitching a part of the card number entered by the merchant with a card data received from the dongle device and authenticating the merchant.

According to an embodiment herein, the step of representing the cipher data as an audio signal comprises filtering the cipher data by a low pass filter and dividing a voltage of cipher data for producing amplitude for the audio signal.

According to an embodiment herein, the step of constructing the hash value out of the encrypted data by the hash function of the client application running on the mobile phone is done by creating a date/time stamp.

According to an embodiment herein, the method for a secure electronic transaction using a dongle device further comprises sending an electronic receipt to the customer through a short message service (SMS) or an e-mail.

According to an embodiment herein, the method for a secure electronic transaction using a dongle device further comprises recording a transaction status by a counter of the microchip.

According to an embodiment herein, the method for a secure electronic transaction using a dongle device further comprises measuring a voltage level of a battery of the dongle by an analog-to-digital convertor (ADC) of the microprocessor, sending a measured voltage level along with the transaction data to the production server, collating a reading of the battery by the payment server, computing a remaining voltage level in the battery by the payment server and sending an information corresponding to the remaining voltage level in the battery to a user.

According to an embodiment herein, the transaction information includes an amount of the transaction, a unique PIN data of the card entered by the card holder, an additional data related to the transaction and a signature of a card holder.

According to an embodiment herein, the unique PIN is data is any one of a scrambled PIN data or a PIN block or a onetime password (OTP).

According to an embodiment herein, the method further comprises an updating of the public key. The updating of the public key comprises swiping a non financial card on a swipe machine, reading a swipe data by a reader head of the dongle device, extracting a public key from the swipe data and updating the public key associated with the dongle device.

According to an embodiment herein, the method further comprises mapping a merchant ID, a terminal ID, a user ID, an IMEI number of computing device, a serial number of the dongle with a dongle ID for executing a secure electronic transaction.

According to an embodiment herein, the method further comprises mapping a dongle ID, a serial number of dongle with an IMEI number of a mobile phone for executing a secure electronic transaction.

According to an embodiment herein, the public key is burned to the dongle device at a manufacture time.

According to an embodiment herein, the dongle generates a session key and a secret key at the beginning of the transaction. The secret key is used for authenticating the payment server. The session key and secret key are encrypted by the public key and sent to the payment server.

According to an embodiment herein, the payment server further comprises a private key and the private key decrypts the secret key sent by the dongle and sends back the decrypted secret key to the dongle for mutually authenticating the dongle device and the payment server.

According to an embodiment herein, the dongle device further comprises a NFC tag and the NFC tag of the dongle device includes a unique ID and a physical unclonable function (PUF).

According to an embodiment herein, the merchant device comprises a NFC tag and the NFC tag of the merchant device authenticates the dongle device by verifying the unique ID of the dongle NFC tag.

According to an embodiment herein, the card data alone is sent as an audio signal after tokenization and encryption.

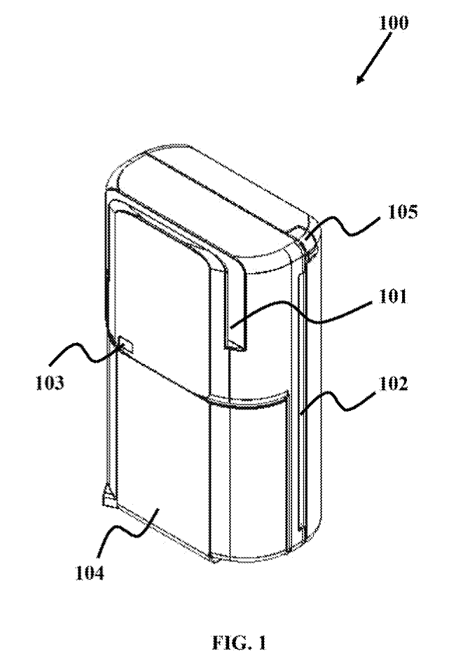

FIG. 1 illustrates a top perspective view of a dongle with a cover, according to an embodiment herein. The dongle device 100 comprises a slot for swiping a magnetic stripe card 101, a slot for inserting a contact type card 102, a communication module, a rechargeable battery, a recharging circuit, a key pad, a connector, a keypad cover 104 for safeguarding the connector, an indicator 103, a stylus 105, a universal serial bus (USB) port, a processor and a display. The contact type card is a europay mastercard and visa (EMV) card. The dongle device 100 also comprises a near field communication (NFC) card reader (not shown in FIG. 1) for reading the NFC when tapped across the dongle device 100. The user uses his/her card for initiating the electronic transaction by swiping the MSR card or inserting the EMV card or tapping the NFC card in the dongle device 100 and corresponding card reader module is activated for reading the card data. The activation of the card module is showcased by illuminating the indicator 104. The stylus 105 is a writing utensil, or a small tool for some other form of marking or shaping or signing. The stylus 105 is also used for navigating or providing more precision when used in a touch screen mobile device connected to the dongle device 100 for the electronic transaction. The rechargeable battery is powered by the recharging circuit when a residual battery level of the rechargeable battery falls below a preset value. The key pad is used to enter PIN and the key pad cover prevents an onlooker from viewing and learning the PIN entered by a user.

According to an embodiment herein, the dongle device is connected to the computing device (i.e. mobile device) for transmitting card data to the server. The card data comprises a transaction information such as an amount of the transaction, a unique PIN of the card entered by the card holder, an additional data related to the transaction and a signature of a card holder.

The processor stores a dongle ID, a serial number of the dongle device 100 and a public key. The dongle ID and the serial number of the dongle device 100 are paired at a time of manufacturing the dongle device 100. The dongle ID is a unique and secret ID associated with the dongle device 100. The public key is used in RSA algorithm for encrypting the card data.

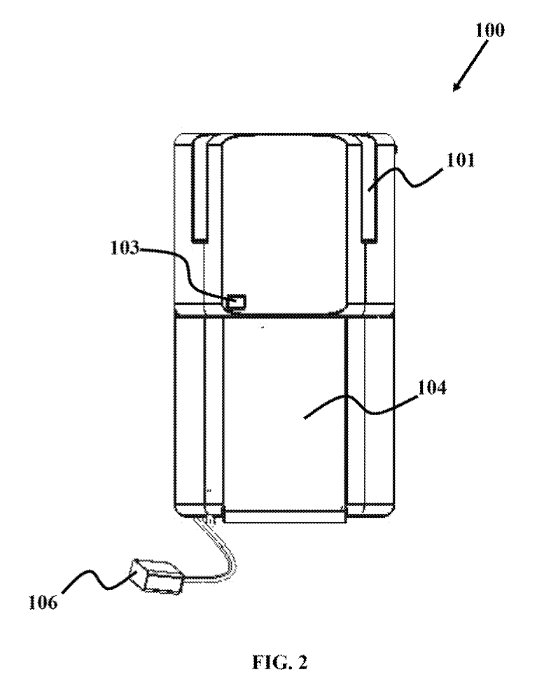

FIG. 2 illustrates a front view of a dongle with a cover, according to an embodiment herein. The dongle device 100 comprises a magnetic stripe reader (MSR) provided in a slot for swiping a magnetic stripe card 101, a europay mastercard and visa (EMV) card reader (not shown in FIG. 2), a near field communication (NFC) card reader (not shown in FIG. 2), an indicator 103, a cover 104 and a lanyard 106. The lanyard 106 is worn around the neck or wrist to carry the dongle device 100.

The user uses his/her card for initiating the electronic transaction by swiping the MSR card or inserting the EMV card or tapping the NFC card in the dongle device 100 and corresponding card reader module is activated for reading the card data. The activation of the card module is showcased by illuminating the indicator 104.

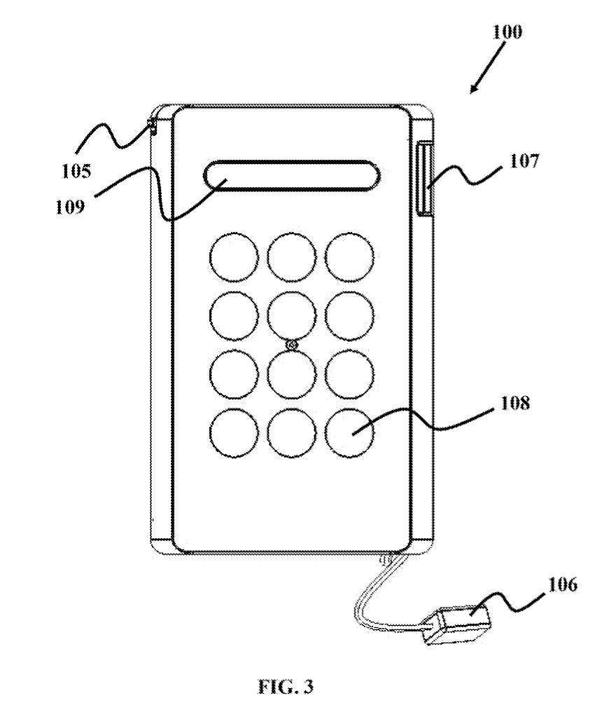

FIG. 3 illustrates a back view of a dongle, according to an embodiment herein. The dongle device 100 comprises a USB socket 107, a keypad 108, a LED display 109, a stylus 105, a lanyard 106 and a rechargeable battery (not shown in FIG. 3). The USB socket 107 is used for charging the rechargeable battery of the dongle device 100. The rechargeable battery supplies a power for the dongle device 100, when the dongle is used independently without connecting to the mobile device. The dongle device 100 further comprises the communication modules for sending the transaction information directly to the server or the payment gateway. The communication modules are a pluggable module to the dongle device 100 through the USB port or in-built in the dongle device 100 at the manufacture time. The dongle device 100 with the in-built communication modules are configured at manufacture time.

The dongle device 100 further comprises a method for composing a PG message (ISO 8583 or equivalent) and sending it directly through a WLAN or GPRS modem on the dongle device 100. The composed payment gateway message is sent to the mobile device and the mobile device sends it directly to the corresponding payment gateway and also the mobile device sends a parallel message to ezetap server.

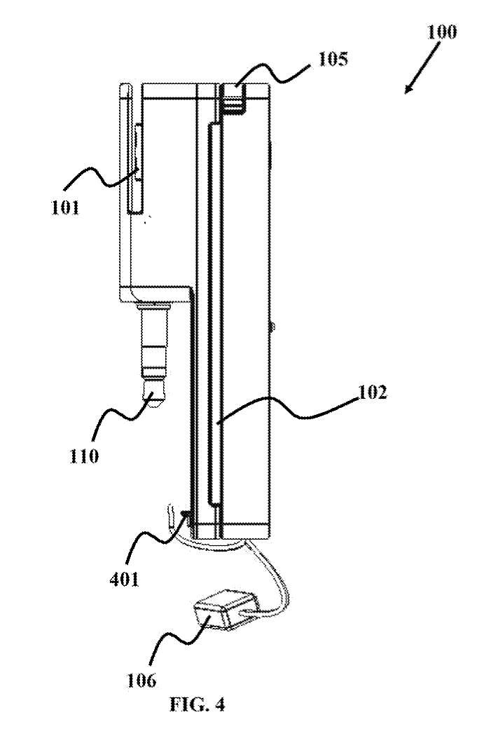

FIG. 4 illustrates a right side view of a dongle without a cover, according to an embodiment herein. The dongle device 100 comprises a magnetic stripe reader (MSR) provided in a slot for swiping a magnetic stripe card 101, a europay MasterCard and visa (EMV) card reader provided in a slot for inserting a contact type card 102, a connector 110, a stylus 105, a lanyard 106 and fastening means 401 for fastening the cover. The card is read and the card data are transmitted through supersonic frequencies to a payment gateway server. The card data are transmitted to a mobile device by connecting the dongle device 100 to the mobile device by the connector 110. The connector of the dongle device is connected to an audio jack of the mobile device. The card data is in the form of analog signals and is a unique data for each of the card.

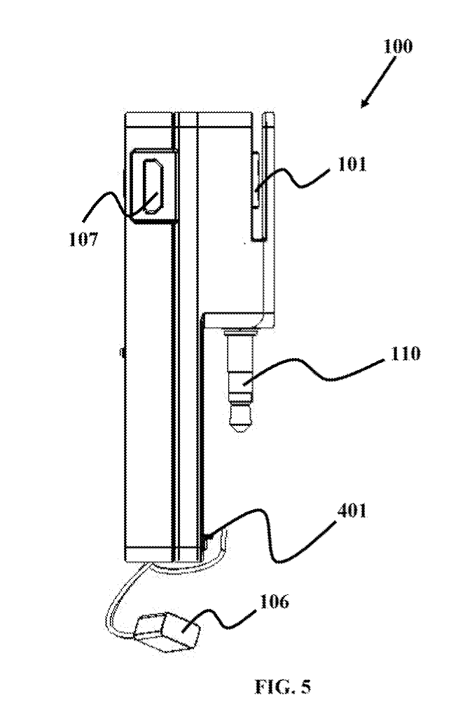

FIG. 5 illustrates a left side view of a dongle without a cover, according to an embodiment herein. The dongle comprises a magnetic stripe reader (MSR) provided in a slot for swiping a magnetic stripe card 101, a USB socket 107, a connector 110, a lanyard 106 and a fastening means 401. The USB socket 107 is used for charging the rechargeable battery of the dongle device 100. The rechargeable battery supplies an electrical power for the dongle device 100, when the dongle device is used independently without connecting to the mobile device. The dongle device 100 further comprises the communication modules for sending the transaction information directly to the server or the payment gateway. The communication modules are a pluggable module to the dongle device 100 through the connector 110 or in-built in the dongle device 100 at the manufacture time. The dongle device 100 with the in-built communication modules are configured at a manufacturing time. The communication module is any of an audio module (audio interface), a Wireless module (WiFi interface), a Bluetooth module, a mobile communication module (GPRS interface) and a zigbee module.

According to an embodiment herein, the connector 110 comprises a power module, a line detector module and a line for establishing a bi-directional data communication. Further the connector 110 also provides a mechanical support for the communication modules connected to the dongle device 100.

According to an embodiment herein, the processor of the dongle device 100 is provided with a software to convert the card data into audio data at supersonic frequencies.

According to an embodiment herein, the communication module connected to the dongle device 100 through the connector 110 interacts with a payment gateway server for completing a transaction.

According to an embodiment herein, the dongle device 100 is connected to the mobile device and a payment transaction is made through a mobile device connected to the dongle device through the audio jack. Further the audio jack supports a payment transaction during a listening of music by enabling a transmission at the audible and supersonic frequencies simultaneously. The communication module links a transaction originated in a cloud computing server with a payment gateway server through a mobile device to complete a financial transaction.

According to an embodiment herein, the processor of the dongle device 100 interacts with an ezetap server through a mobile device or with the ezetap server directly. The processor interacts not only with the ezetap server through a mobile device but also with the payment gate way server.

According to an embodiment herein, the audio jack supports both a data transmission and an audio transmission with the mobile device.

According to an embodiment herein, a communication over the audio jack is done through the noise like signals and wherein the noise like signals is spread spectrum signals and wherein the spread spectrum signals are generated using hardware and software.

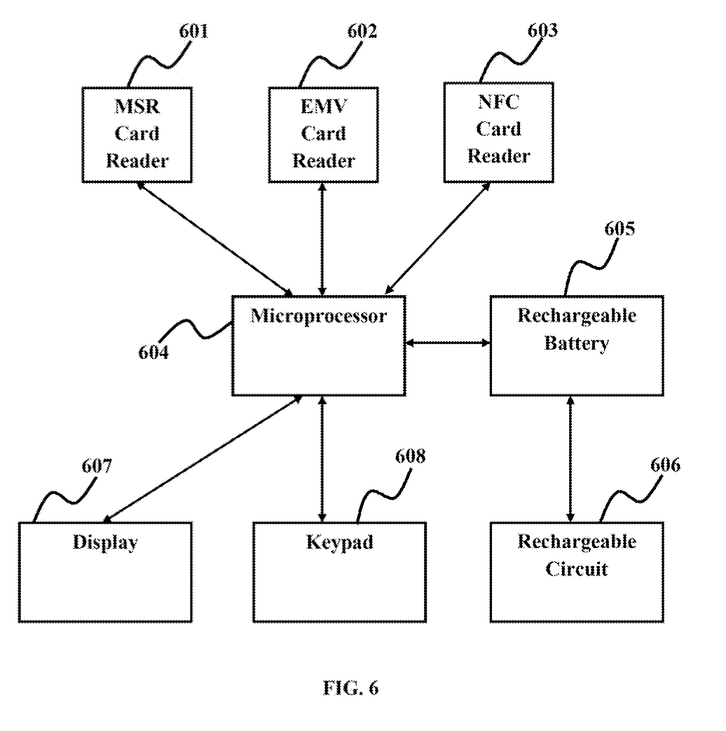

FIG. 6 illustrates a functional block diagram of a dongle device with a rechargeable power supply for a secure electronic transaction, according to an embodiment herein. The dongle device comprises a MSR card reader 601, a EMV card reader 602, a NFC card reader 603, a microprocessor 604, a rechargeable battery 605, a recharging circuit 606, a display 607 and a keypad 608. The microprocessor 604 of the dongle device further comprises an analog-to-digital convertor (ADC) for measuring a voltage level of the rechargeable battery 605. The dongle device further comprises a slot for reading the card. The card is inserted into the slot adopted on the dongle device. The reading of the card is done without a swipe action. The slot further comprises an internal circuitry which includes an EMV card reader 602, a MSR card reader 601 and a NFC card reader 603 for reading a EMV card, a MSR card and a NFC card respectively. The rechargeable battery 605 is powered by the recharging circuit 606 when a residual battery level of the rechargeable battery 605 falls below a preset value. The key pad 608 is used to enter a PIN and the key pad cover is adopted on the keypad 608 to prevent an onlooker from viewing and learning the PIN entered by a user. The display 607 displays the entered PIN from the keypad 608.

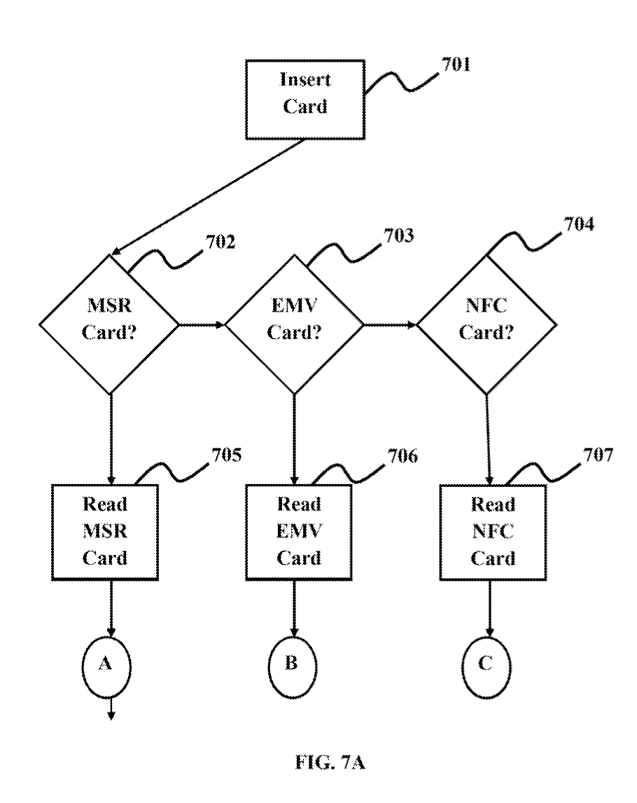

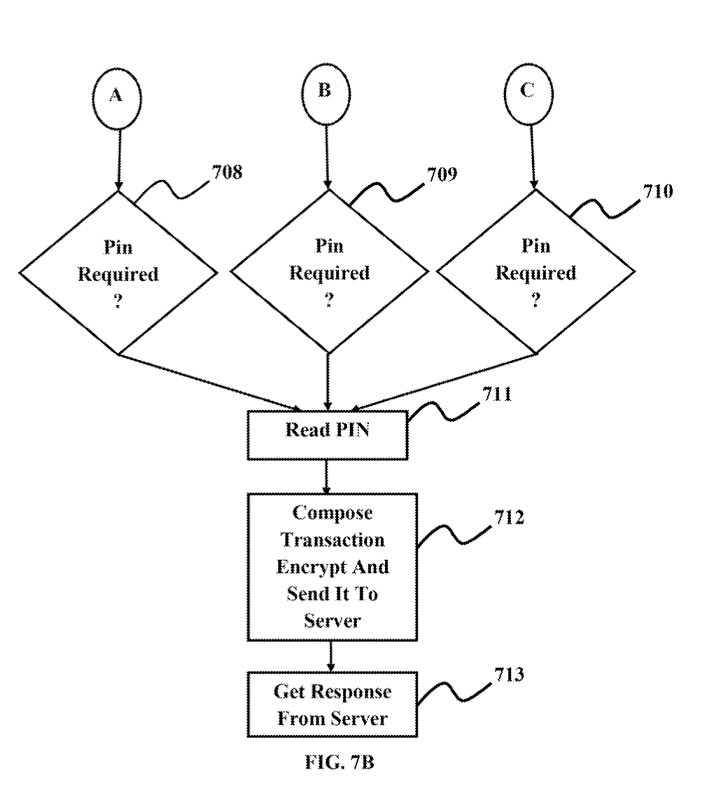

FIG. 7A and FIG. 7B jointly illustrates a flowchart for a method of secure electronic transaction, according to an embodiment herein. The user inserts the card into the slot adopted on the dongle device (701). The reading of the card is done without a swipe action. The slot further comprises an internal circuitry which includes the EMV card reader, the MSR card reader and the NFC card reader for reading a EMV card, a MSR card and a NFC card respectively. The internal circuitry recognizes the type of card inserted into the slot as MSR card (702) or EMV card (703) or NFC card (704) and similarly activates the corresponding card reader such as MSR card reader (705) or EMV card reader (706) or NFC card reader (707) respectively. The card data is read by the respective card reader and further a check is done for requiring the PIN to be provided by the user in-order to initiate the transaction procedure. The PIN check is done for MSR card (708) or EMV card (709) or NFC card (710). If required, the PIN is to be entered by the user for certain type of cards and the PIN is read by the card reader (711) for any type of card like MSR card or EMV card or NFC card. The transaction data is composed. The transaction data including the card data, PIN, transaction amount, etc are encrypted and sent to the server for a secure transaction (712). After receiving the encrypted transaction data from the dongle device, the server decrypts the transaction data and sends it to the payment gateway for completing the transaction securely. After successful transaction, the server acknowledges the dongle device by sending a transaction receipt (712).

The embodiments herein provide a dongle device for a secure electronic transaction. The embodiments herein provide a dongle device which can connect directly to a server or a payment gateway to perform a secure electronic transaction without the need of a mobile device. The dongle device of the embodiments herein includes a rechargeable battery and a recharging circuit. The rechargeable battery is powered by the recharging circuit when a residual battery level of the rechargeable battery falls below a preset value to enable a fast, efficient, cost effective and secure electronic transaction even without the need of the external device like mobile device. The method of the embodiments herein provides a secure electronic transaction by transforming a card data into a token data and transmitting the token data without sending the card data from a computing device to a server. The dongle device of the embodiments herein converts the card data into audio data at supersonic frequencies. The dongle device of the embodiments herein converts the card data into noise like signals i.e. spread spectrum signals. The dongle device of the embodiments herein provides a tamper proof characteristic for a secure electronic transaction. The dongle device also provides a security mesh for prevent a drilling to avoid a tampering of key board. The dongle device provides a method for mutually authenticating the dongle device and the payment server.

The foregoing description of the specific embodiments herein will so fully reveal the general nature of the embodiments herein that others can, by applying current knowledge, readily modify and/or adapt for various applications such specific embodiments herein without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A dongle device with rechargeable power supply for a secure electronic transaction comprising:
a slot for swiping a magnetic stripe card;
a slot for inserting a contact type card;
a rechargeable battery;
a recharging circuit;
a key pad;
a key pad cover,
a connector, wherein the connector is an audio jack;
a cover for safeguarding the connector;
a stylus;
a universal serial bus (USB) port;
a processor, and
a display;
wherein the rechargeable battery is powered by the recharging circuit when a residual battery level of the rechargeable battery falls below a preset value, and wherein the key pad is used to enter personal identification number (PIN) and wherein the key pad cover prevents an onlooker from viewing and learning the PIN entered by a user.

2. The dongle device according to claim 1, wherein the PIN data is any one of a scrambled PIN data or a PIN block or a onetime password.

3. The dongle device according to claim 1, wherein the pre-set value is set by a user.

4. The dongle device according to claim 1 further comprises a public key burned at a time of manufacture the dongle.

5. The dongle device according to claim 1, wherein the processor generates a session key and a secret key at a beginning of the transaction, and wherein the secret key is used for authenticating the payment server, and wherein the session key and secret key are encrypted by the public key before sending to the payment server.

6. The dongle device according to claim 1, wherein the payment server further comprises a private key, and wherein the private key decrypts the secret key sent by the dongle and sends back the decrypted secret key to the dongle for mutually authenticating the dongle and the payment server.

7. The dongle device according to claim 1 further comprises a magnetic card reader, a contact type card reader and a near field communication (NFC) reader.

8. The dongle device according to claim 1, wherein a magnetic card reader or a contact type card reader or the NFC reader is activated accordingly when a magnetic card is swiped through the slot for swiping a magnetic stripe card or when a contact type card is inserted through the slot for inserting a contact type card or when a NFC card is tapped.

9. The dongle device according to claim 1, wherein the connector comprises a power module, a line detector module and a line for establishing a bi-directional data communication.

10. The dongle device according to claim 1, wherein the connector provides a mechanical support.

11. The dongle device according to claim 1, wherein the processor is provided with software to convert the card data into audio data at supersonic frequencies.

12. The dongle device according to claim 1, wherein the communication module interacts with a payment gateway server for completing a transaction.

13. The dongle device according to claim 1, wherein a payment transaction is made through a mobile phone connected to the audio jack of the dongle device.

14. The dongle device according to claim 1, wherein the audio jack supports a payment transaction during a listening of music by enabling transmission at audible and supersonic frequencies simultaneously.

15. The dongle device according to claim 1, wherein the communication module links a transaction originated in a cloud computing server with a payment gateway server through a mobile phone to complete a financial transaction.

16. The dongle device according to claim 1, wherein the processor interacts with a central server through a mobile phone or with the central server directly.

17. The dongle device according to claim 1, wherein the processor interacts not only with the central server through a mobile phone but also with the payment gate way server.

18. The dongle device according to claim 1, wherein the audio jack supports both a data transmission and an audio transmission with the mobile phone.

19. The dongle device according to claim 1, wherein the audio jack supports a two way communication between a mobile phone and the dongle.

20. The dongle device according to claim 1, wherein the audio jack supports a two way encrypted link.

21. The dongle device according to claim 1, wherein a communication over the audio jack is done through a noise like signals and wherein the noise like signals is spread spectrum signals and wherein the spread spectrum signals are generated using a hardware and a software.

22. A method for a secure electronic transaction using a dongle device comprising the steps of:
logging in by a merchant into a client application installed on a computing device;
swiping a card onto a dongle device;
tracking a status of a swipe;
reading a swipe data by a magnetic card reader of the dongle device;
extracting a public key burnt on a flash of the dongle device;
processing the swipe data by a microchip for producing a cipher data;
representing the cipher data and a PIN data as an audio signal;
transmitting the cipher data and the PIN data to a mobile device through an audio jack of the mobile device, and wherein the data communicated between the mobile phone and the dongle device is in a form of acoustic signals or audio tones;
collecting a transaction information through a graphical user interface (GUI) and wherein the GUI is provided by the client application;
collecting a part of a card number from the merchant;
constructing a hash value out of the cipher data by using a hash algorithm of a client application running on a computing device and wherein the hash algorithm is exchanged and stored between the mobile device and the payment server for a first time;
transmitting the hash value along with the transaction information to a production server through a first communication network;
processing the cipher data and the PIN data in a payment server of the production server;
sending a transaction request to a third party system to perform an electronic transaction;
transmitting a transaction information to the third party system through a second communication network;
performing the electronic transaction by the third party system; and
indicating a transaction status and wherein the transaction status is indicated by an audio tone or a colored light, and wherein the transaction status is one of a bad transaction and a good transaction.

23. The method of claim 22, wherein the step processing the swipe data by a microchip for producing a cipher data comprises:
generating a random number for avoiding a replay attack;
decoding the swipe data by a comparator,
converting the swipe data into a card data by a converter;
tokenization of the card data by a tokenizer by Xoring the card data with a dongle ID;
encrypting the card data into a cipher data by an encryption engine using a RSA algorithm, and wherein a public key is used in RSA algorithm for encrypting the card data; and
modulating the cipher data by a modulation engine using Frequency Shift Keying (FSK);
wherein the dongle ID is a unique and secret ID related to the dongle device.

24. The method of claim 22, wherein the step of processing the cipher data in a payment server of the production server comprises:
decoding the hash value by a decoder of the payment server for producing the cipher data;
decrypting the cipher data by a decryption engine of the payment server using a private key;
retrieving a merchant information stored in a payment database of the production server,
reproducing a complete card number by stitching a part of the card number entered by the merchant with a card data received from the dongle device; and
authenticating the merchant.

25. The method of claim 22, wherein the step of representing the cipher data as an audio signal comprises:
filtering the cipher data by a low pass filter, and
dividing a voltage of cipher data for producing an amplitude for the audio signal.

26. The method of claim 22, wherein the step of constructing the hash value out of the encrypted data by the hash function of the client application running on the mobile phone is done by creating a date/time stamp.

27. The method of claim 22, wherein the method further comprises sending an electronic receipt to the customer through a short message service (SMS) or an e-mail.

28. The method of claim 22, wherein the method further comprises recording a transaction status by a counter of the microchip.

29. The method of claim 22, wherein the method further comprises:
measuring a voltage level of a battery of the dongle by an analog-to-digital convertor (ADC) of the microprocessor;
sending a measured voltage level along with the transaction data to the production server;
collating a reading of the battery by the payment server;
computing a remaining voltage level in the battery by the payment server, and
sending an information corresponding to the remaining voltage level in the battery to a user.

30. The method of claim 22, wherein the transaction information includes an amount of the transaction, an unique PIN data of the card entered by the card holder, an additional data related to the transaction, and a signature of a card holder.

31. The method according to claim 22, wherein the unique PIN is data is any one of a scrambled PIN data or a PIN block or a onetime password (OTP).

32. The method of claim 22, wherein the method further comprises an updating of the public key, and wherein the updating of the public key comprises swiping a non financial card on a swipe machine, reading a swipe data by a reader head of the dongle device, extracting a public key from the swipe data and updating the public key associated with the dongle device.

33. The method according to claim 22 further comprises mapping a merchant ID, a terminal ID, a user ID, IMEI number of computing device, a serial number of the dongle with a dongle ID for executing a secure electronic transaction.

34. The method according to claim 22 further comprises mapping a dongle ID, serial number of dongle with IMEI number of a mobile phone for executing a secure electronic transaction.

35. The method according to claim 22, wherein the public key is burned to the dongle device at a manufacture time.

36. The method according to claim 22, wherein the dongle generates a session key and a secret key at the beginning of the transaction, and wherein the secret key is used for authenticating the payment server, and wherein the session key and secret key are encrypted by the public key and sent to the payment server.

37. The method according to claim 22, wherein the payment server further comprises a private key, and wherein the private key decrypts the secret key sent by the dongle and sends back the decrypted secret key to the dongle for mutually authenticating the dongle device and the payment server.

38. The method according to claim 22, wherein the dongle further comprises a NFC tag, and wherein the NFC tag of the dongle device includes a unique ID and a physical unclonable function (PUF).

39. The method according to claim 22, wherein the merchant device comprises a NFC tag, and wherein the NFC tag of the merchant device authenticates the dongle by verifying the unique ID of the dongle NFC tag.

40. The method according to claim 22, wherein a swipe data alone is sent as an audio signal after tokenization and encryption.
